(19) United States
(12) Patent Application Publication
(10) Pub. No.: US 2015/0149548 A1
(43) Pub. Date: May 28, 2015

(54) SYSTEM FOR SHARING NETWORK MULIMEDIA DATA

(71) Applicant: MtoV Inc., Daejeon (KR)

(72) Inventor: Sangsu JUNG, Seoul (KR)

(21) Appl. No.: 14/520,651

(22) Filed: Oct. 22, 2014

(30) Foreign Application Priority Data
Nov. 26, 2013 (KR) 10-2013-0144198

(51) Int. Cl. H04L 29/08

(52) U.S. Cl. CPC H04L 67/18; H04L 67/104
USPC 709/204

(57) ABSTRACT

The present disclosure relates to a system for sharing network multimedia data, including, in accordance with one exemplary embodiment of the present invention, a first display portion which displays a first information about a surrounding area, and a second display portion which displays a first image provided by a surrounding device in the surrounding area, and having the surrounding device connected to a same ad hoc network, over which the first image is received.

### CROSS-REFERENCE TO RELATED APPLICATION

This application claims the priority of the Korean Patent Application No. 10-2013-0144198 filed on Nov. 26, 2013 in the Korean Intellectual Property Office, and all the benefits accruing therefrom under 35 U.S.C. §119, the contents of which in their entirety are herein incorporated by reference.

### TECHNICAL FIELD

The present invention relates to a system for sharing network multimedia data, and more particularly, to a system for sharing network multimedia data which enables sharing of a certain amount of multimedia data over ad hoc network.

### BACKGROUND ART

Ad hoc network refers to a network which is self-organized by wireless nodes without any infrastructure such as a base station or cable. Ad hoc nodes communicate each other by using wireless interface, and the network topology changes dynamically. Its application fields include an emergency relief, an urgent conference, military networks, and vehicular networks.

The conventional art, wherein the detection of impact is linked with network devices, is intended for a system which transmits small amount of data through Bluetooth or RFID when the impact has been detected.

For the data management technology linked with wireless network, there is a network device based on content caching, wherein the data cached can be wirelessly transmitted upon request.

### DISCLOSURE OF INVENTION

### Technical Problem

In the conventional technology on composition of ad hoc network, the network holding time based on connectivity between the nodes is not taken into account, incurring unnecessary nodes being included in the ad hoc network group thereby deteriorating the performance. In addition, there is no proper system setting up the size of ad hoc network, resulting in lowered communication efficiency as in case of high density of nodes the packets frequently collide and the waiting time is prolonged due to a large amount of nodes included in a single sub-network at the same time.

Meanwhile, the conventional device for transmitting multimedia data is equipped with a single memory portion. Thus, it saves its own data mixed with those of the other devices, taking considerable time for data recording and extraction due to a limitation of the memory performance. Moreover, the method of database management, in consideration of the connection with an external server such as a base station, is absent.

The present invention is to resolve the above mentioned technical issues by providing a system for sharing network multimedia data which enables sharing of multimedia data in real time by connecting a multimedia data transmittable device over an ad hoc network.

Also, the present invention, in order to resolve another technical issue, is to provide a system for sharing network multimedia data which performs data transmission when the impact is detected or during the prescribed time period, considering the connectivity between the multimedia transmitting devices as network nodes, by setting up the network nodes as in the same group only when the network holding time is above a certain point.

To resolve further technical issue, the present invention is to provide a system for sharing network multimedia data which promptly transmits data to a plurality of multimedia transmitting devices by using wireless network technology in order to prevent from losing data when the impact is detected on the multimedia transmitting device.

The technical issues the present invention is to resolve are not limited to the above mentioned, but other issues not mentioned herein will be clearly understandable for those having ordinary skill in the art upon the description which follows.

### Technical Solution

In order to resolve the above mentioned technical issues, the system for sharing network multimedia data in accordance with one exemplary embodiment of the present invention includes a first display portion which displays a first information about a surrounding area, and a second display portion which displays a first image provided by a surrounding device in the surrounding area. The surrounding device is connected on a same ad hoc network, over which the first image is received.

Also, it may further includes a sensor portion which detects the amount of the impact applied onto the body of its own, and a control portion which transmits a second image of the body of a car, at the time the accident took place, to the surrounding device over the ad hoc network when the sensor portion detects the external impact.

The control portion of the surrounding device or the host device can transmit the accident report data including the first image or the second image to an external server which is collecting images of an accident.

The first display portion may further display a second information including distribution or location of the surrounding device in the surrounding area, and the second display portion may display a first black box image of the surrounding device when the surrounding device, displayed on the first display portion, is chosen.

The first display portion may further display the second information including distribution or location of the surrounding device in the surrounding area, and the second display portion may display a third image provided by an adjacent device at a specific spot which is chosen in the surrounding area.

### Advantageous Effects

The present invention has various effects as in the following.

First, the system for sharing network multimedia data in accordance with the exemplary embodiments of the present invention reduces frequency of unnecessary data transmission to the node which is prone to be disconnected since ad hoc network is established by multimedia transmitting devices on the basis of the prediction of link time between the nodes.

Second, the system for sharing network multimedia data in accordance with the exemplary embodiments generates efficient network traffic and expedites network composition by limiting the number of a multimedia transmitting device as a node to be included in the ad hoc network which is composed of a single subnet.

Third, the system for sharing network multimedia data in accordance with the exemplary embodiments prevents from losing important data when the impact is detected by an impact detecting sensor of the multimedia transmitting device by promptly transmitting data of a specific frame wirelessly, linked with an image processing portion and a network transmitting portion, to a neighboring multimedia transmitting device.

Forth, the system for sharing network multimedia data in accordance with the exemplary embodiments enables management of dual storage of data since it transmits important data frame to neighboring multimedia transmitting devices or a base station at an interval of a certain time period.

Fifth, the system for sharing network multimedia data in accordance with the exemplary embodiments of the present invention assures high speed of memory access as it properly distributes and saves data in a memory portion composed of dual memory, and extract data therefrom, depending upon the origin of data.

Sixth, the system for sharing network multimedia data in accordance with the exemplary embodiments provides a system that enables multimedia transmitting devices and the base station to efficiently manage data.

### BRIEF DESCRIPTION OF DRAWINGS

FIG. 1 is a block diagram illustrating an outline of composition of the system for sharing network multimedia data in accordance with one exemplary embodiment of the present invention.

FIG. 2 and FIG. 3 are diagrams illustrating the relationship among a plurality of devices to which the system for sharing network multimedia data of FIG. 1 is applied.

FIG. 4 and FIG. 5 are diagrams illustrating a process of sharing multimedia data when the devices of FIG. 3 are colliding.

FIG. 6 and FIG. 7 are diagrams illustrating an outline of composition of the system for sharing network multimedia data in accordance with another exemplary embodiment of the present invention.

FIG. 8 is a block diagram illustrating a composition of a device comprising the system for sharing network multimedia data in accordance with further exemplary embodiment of the present invention.

FIG. 9 is a flow chart describing a method of formation of an ad hoc network group by the devices in the system for sharing network multimedia data in accordance with the exemplary embodiments of the present invention.

FIG. 10 is a flow chart describing a method of transmitting data to a surrounding device when the impact is detected in the system for sharing network multimedia data in accordance with the exemplary embodiments of the present invention.

FIG. 11 is a flow chart describing a method of transmitting data when the message about impact detection is received in the system for sharing network multimedia data in accordance with the exemplary embodiments of the present invention.

### BEST MODE OF CARRYING OUT THE INVENTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A same reference mark used refers to a same element throughout the description.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

The system for sharing network multimedia data in accordance with the exemplary embodiments of the present invention will be described in reference with the drawings as in the following.

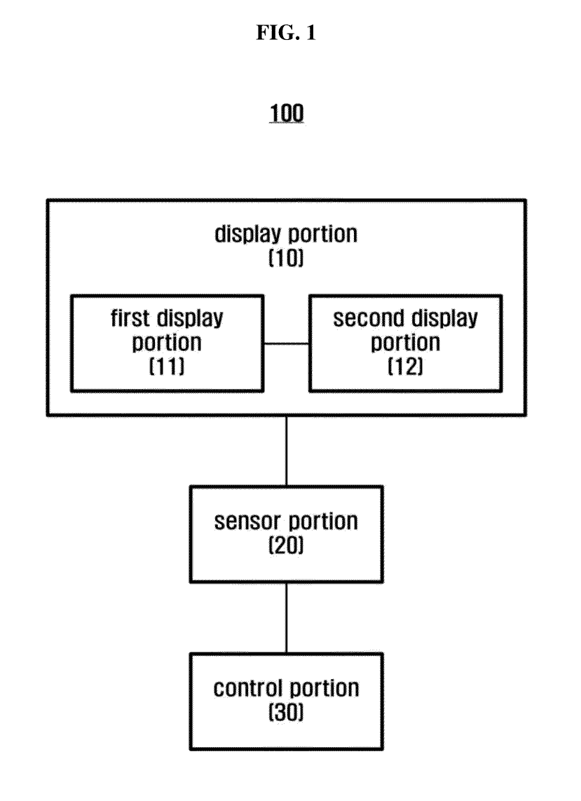

FIG. 1 shows the system for sharing network multimedia data (100) in accordance with one exemplary embodiment of the present invention, including a first display portion (11) which displays a first information about a surrounding area, and a second display portion (12) which displays a first image provided by a surrounding device in the surrounding area, and having the surrounding devices connected on a same ad hoc network, over which the first image is received.

A display portion (10) includes the first display portion (11) and the second display portion (12). Each of the first display portion (11) and the second display portion (12) may be composed of a separate display device, while not limited thereto, but each may also have separate monitors shown in one display device.

The first display portion (11) displays the first information about the surrounding area, for example, the information about the form of the surrounding road or the lay of the land, and the information about distribution or location of the surrounding device existing on the same network

In the present exemplary embodiment, a surrounding device may refers to many different kinds, including a mobile device, which is connected to a network, enabling mutual data transmission, or all kinds of various means equipped with such mobile devices. However, it is not limited thereto.

The second display portion (12) displays the first image received from the surrounding device existing within a prescribed range of a host device (the body). That is, a plurality of devices connected on a certain network can share each other's condition and views by mutually sharing multimedia data such as an image. In order for that, a plurality of devices may include a camera module generating multimedia data by taking a picture of either the inside or the outside.

In addition, the host device and its surrounding devices can be connected with each other on a same ad hoc network, and the first image can be shared over the ad hoc network.

A sensor portion (20) detects the amount of impact applied onto the body of its own and transmits the result to a control portion (30). The sensor portion (20) may include various compositions detecting the amount of impact applied onto either the inside or the outside.

The control portion (30) controls the display portion (10) and the sensor portion (20), more particularly, processes multimedia data received over ad hoc network so as to provide the processed data to the display portion (10), and displays the first information on the basis of the data already saved.

Moreover, when the sensor portion (20) detects an impact, the control portion (30) transmits a second image of the host device, at the time the accident took place, to the surrounding device over ad hoc network. The term ‘accident’ in the present description refers to all kinds of event wherein the impact is detected on the host or surrounding devices.

In other words, the control portion (30) transmits the first image received from the outside to the display portion (10), and transmits the second image acquired on its own to a surrounding device in the outside.

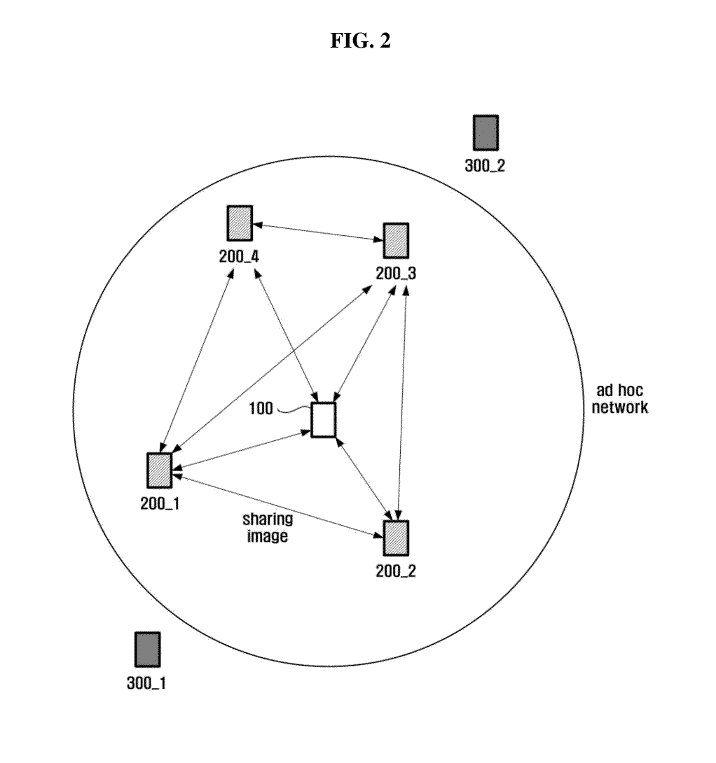

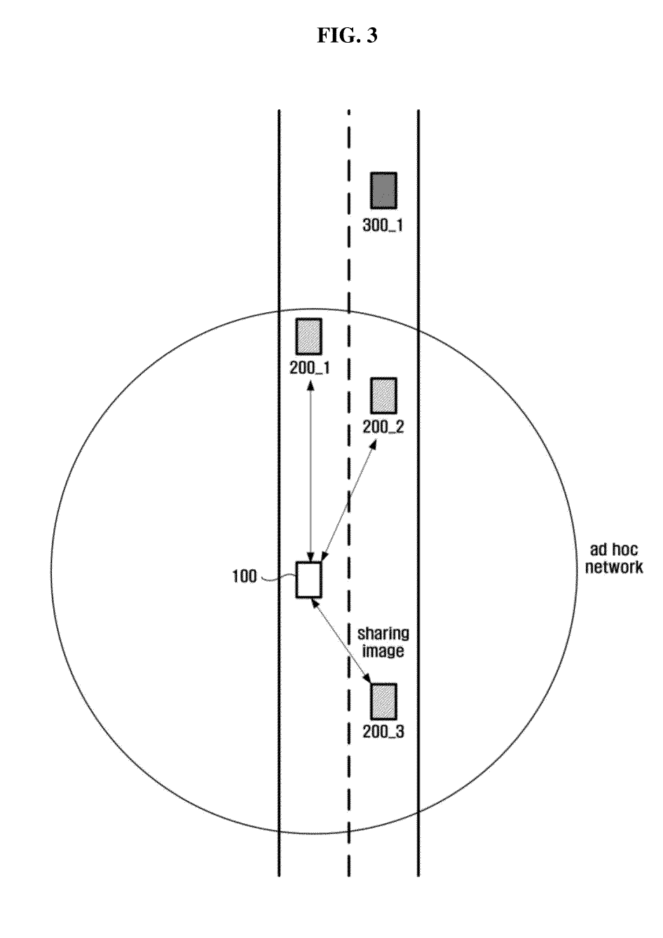

FIG. 2 and FIG. 3 shows the exemplary embodiments of the system for sharing network multimedia data (100) in various devices.

In reference with FIG. 2, ad hoc network is established in a prescribed range with the host device (100) as its center, and a certain amount of images can be shared not only with the host device (100) but also among the surrounding devices (200_1, 200_2, 200_3, 200_4; marked as 200 hereinafter) existing on the network. Such an image sharing can be made as a result of a specific event, or by periodically outputting an image received from another device.

As previously explained, the host device (100) and the surrounding device (200) refer to various forms of device which has composition of transmitting and receiving data over a network.

Non-surrounding devices (300_{—1}, 300_2) existing outside of the ad hoc network cannot perform image sharing over the ad hoc network because it is not connected with the host device (100). However, the images may possibly be shared by means of communications other than ad hoc network such as mobile or broadband.

In reference with FIG. 3, the host device (100) and the surrounding device (200) can be a car itself in motion or a modular composition equipped inside of the car. That is, the host device (100), as a car of one's own, and the car existing within a certain range can share each other's images by communicating over the ad hoc network.

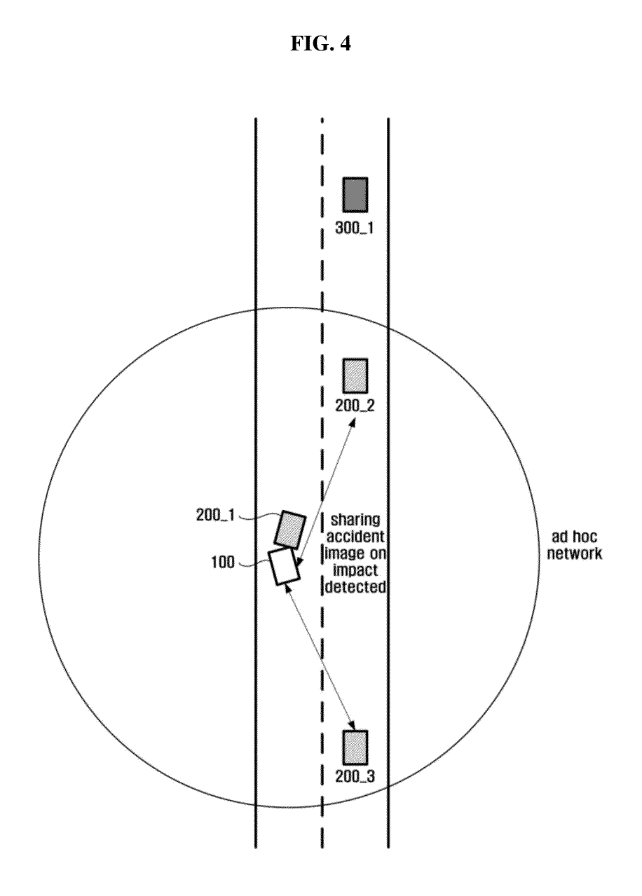

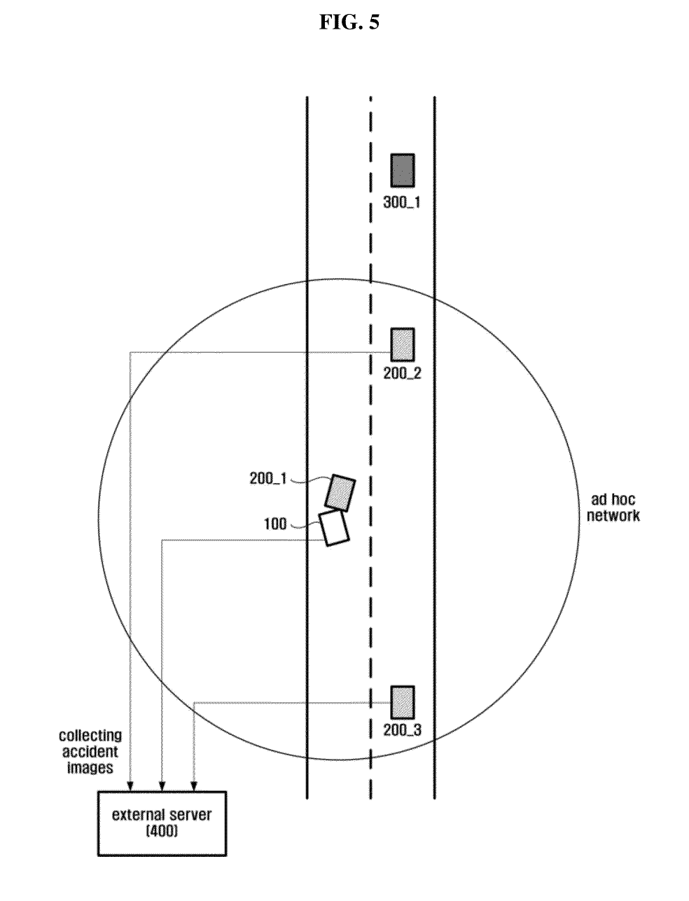

FIG. 4 and FIG. 5 show the process of sharing image when the host device (100) detects an impact.

In reference with FIG. 4, for example, when the car of one's own (100) detects an impact caused by a collision with the other car (200_1), the car of one's own (100) can share the images of the accident by sending out the black box images, taken before and after the collision, to the surrounding cars (200_2, 200_3) existing on the ad hoc network. Although not shown by the drawing, the other car (200_1) in the accident also can send out the images to the surrounding cars (200_2, 200_3) connected on the ad hoc network.

In reference with FIG. 5, the control portion of the surrounding device, that is, surrounding cars (200_2, 200_3), or the host device, that is, the car of one's own (100), transmits accident report data including the first image or the second image to an external server (400), and the external server (400) collects such accident report data. For example, the external server (400) can be arranged in the location related to a car, such as an insurance company, police station, or hospital. The external server (400), by collecting images from various angles for a single accident, contributes to the improvement of reliability and accuracy of judgment.

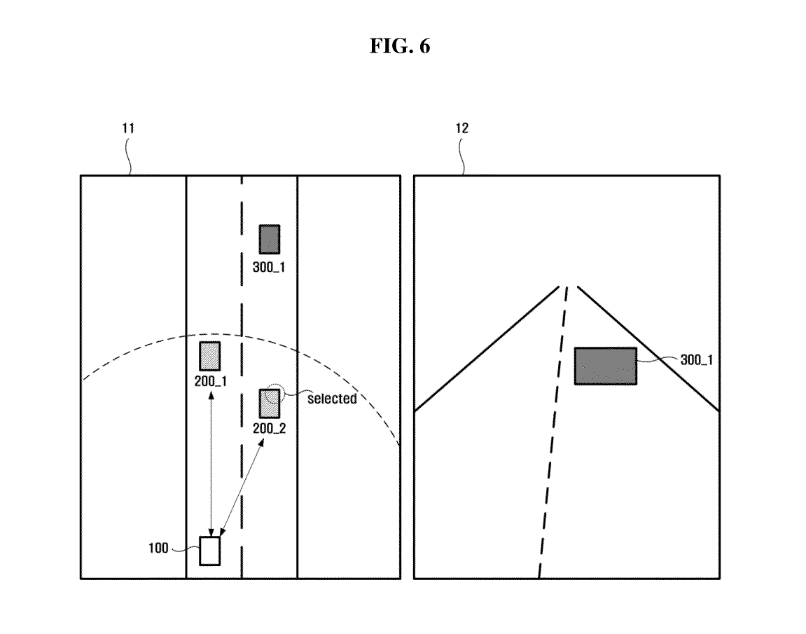

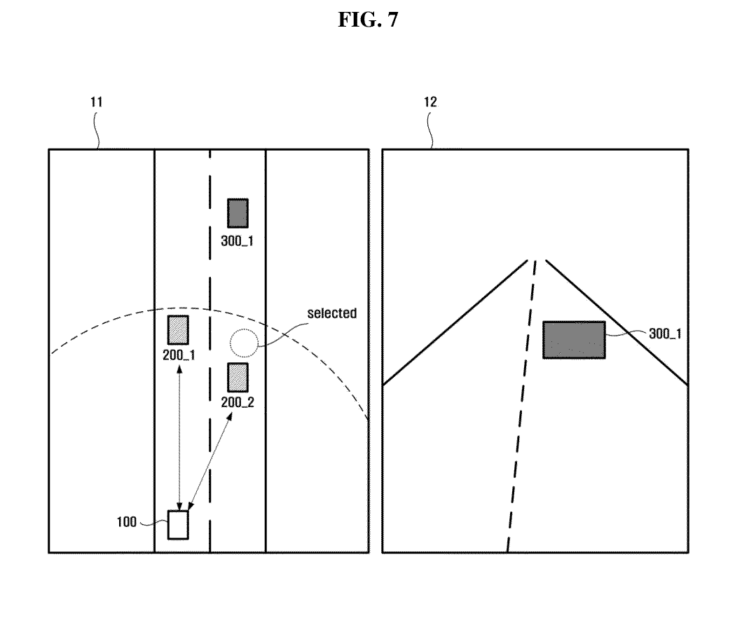

FIG. 6 and FIG. 7 shows an outline of composition of the system for sharing network multimedia data in accordance with another exemplary embodiment of the present invention.

In reference with FIG. 6, the first display portion (11) may further display a second information including distribution or location of the surrounding devices (200_1, 200_2) existing in the surrounding area. And the second display portion (12) may display a third image of the surrounding device (200_2), given the surrounding device (200_2) which is displayed on the display portion (11) has been chosen. In order for that, the first display portion (11) may be composed of a touch display panel, and display, on the second display portion (12), the shared multimedia data provided by the surrounding device (200_2) on the basis of the information about the surrounding device (200_2) which is chosen by a user's touch being detected.

In reference with FIG. 7, the first display portion (11) may further display a second information including distribution or location of the surrounding devices (200_1, 200_2) existing in the surrounding area, and the second display portion (12) may display a forth image provided by an adjacent device (200_2) at a specific spot, given the spot in the surrounding area is chosen. In order for that, the first display portion (11) may be composed of a touch display panel, and display, on the second display portion (12), the shared multimedia data received from the surrounding device (200_2) on the basis of the information about the surrounding device (200_2) most adjacent to the spot chosen by a user's touch being detected.

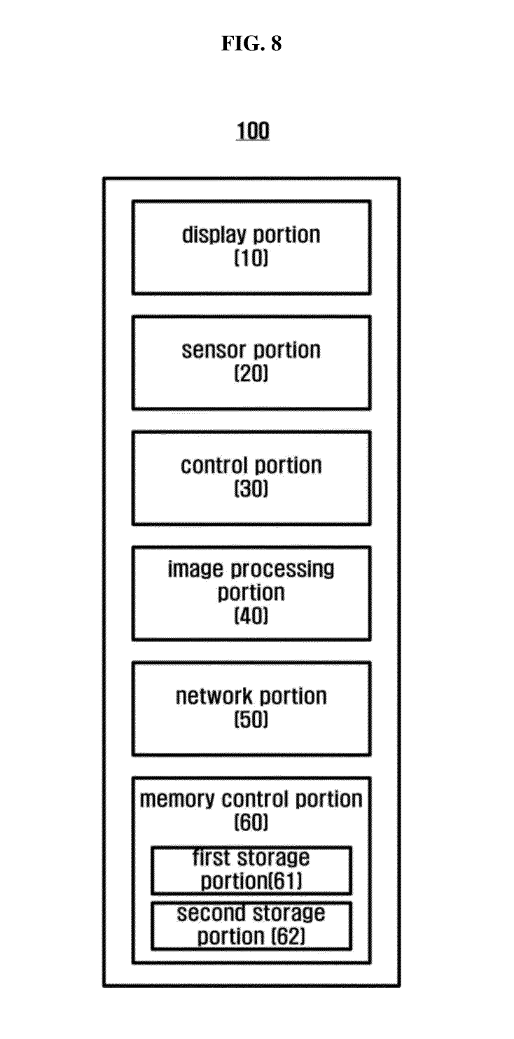

FIG. 8 shows a composition of the device which comprises the system for sharing network multimedia data in accordance with further exemplary embodiment of the present invention, further including an image processing portion (40), a network portion (50), and a memory control portion (60), as well as the display portion (10), the sensor portion (20), and the control portion (30), which are previously explained.

The image processing portion (40) records an image acquired from an image taking portion (not shown), and extracts a specific frame of the image periodically or when the impact is detected.

The network portion (50) selects a single or a plurality of surrounding devices to be included in the ad hoc network group depending upon the link expiration time and the distance between the devices, and transmits the extracted image frame to the device selected from the network group, to an external server, or to a base station.

The memory control portion (60) records and maintains each of the images recorded and transmitted. The memory control portion (60) assures fast memory access by properly distributing and saving data to, and extracting the data from, a dual memory composed of a first storage portion (61) and a second storage portion (62), depending upon the origin of data.

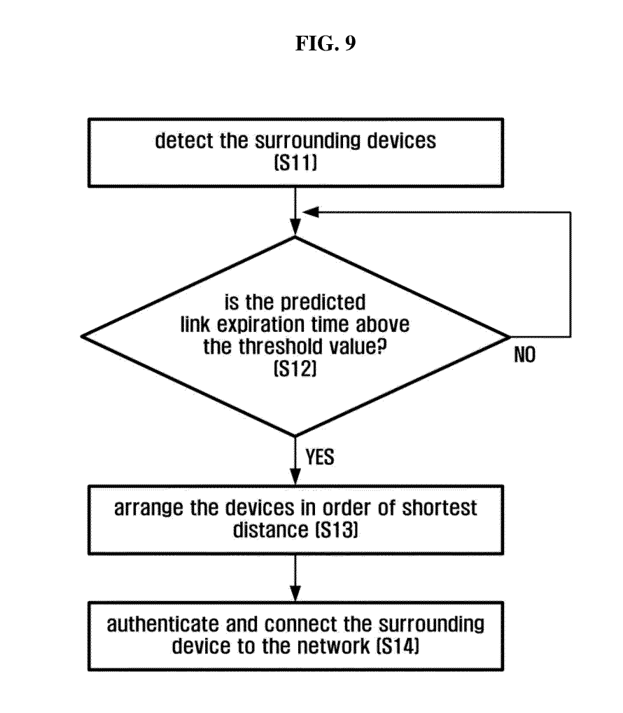

FIG. 9 is a flow chart describing a method of forming ad hoc network group by the devices in the system for sharing network multimedia data in accordance with the exemplary embodiments of the present invention.

The device comprising the system for network multimedia data will be hereinafter called a network multimedia device.

The host device (the body), either in motion or static, comprising the system for network multimedia data detects (S11) the surrounding devices in the area around itself. Among the devices detected, then it selects (S12) the devices which has the predicted link expiration time above the prescribed value (t), arranges (S13) the selected devices in the order of shortest distance, and authenticates and connects (S14) the satisfying device over the network in order for network transmission.

At this, the method of calculating the predicted link expiration time is as in the following.

By using a location information (xⱼ,yᵢ) of a surrounding device, for example, a surrounding network multimedia device (j), a relative moving speed (vₓ,v_{y}), and a transmission range (d) of a moving node (i), a duration of link expiration time (tᵢⱼ) can be predicted as in the following Mathematical Formula 1.

$${t}_{ij} = \frac{- ( {v}_{x} {r}_{x} + {v}_{y} {r}_{y} ) + \sqrt{\begin{matrix}( {v}_{x}^{2} + {v}_{y}^{2} ) {d}^{2} - \\ {( {v}_{x} {r}_{y} - {v}_{y} {r}_{x} )}^{2}\end{matrix}}}{{v}_{x}^{2} + {v}_{y}^{2}} \qquad [ Mathematical Formula 1 ]$$

At this, vₓ and v_{y} refer to the relative moving speeds of a surrounding network multimedia device (j) to an each direction of x-axis and y-axis to a network multimedia device (i).

rₓ nd r_{y} refer to relative coordinates along the x-axis and y-axis, respectively, of a surrounding network multimedia device (j) to a moving node (i).

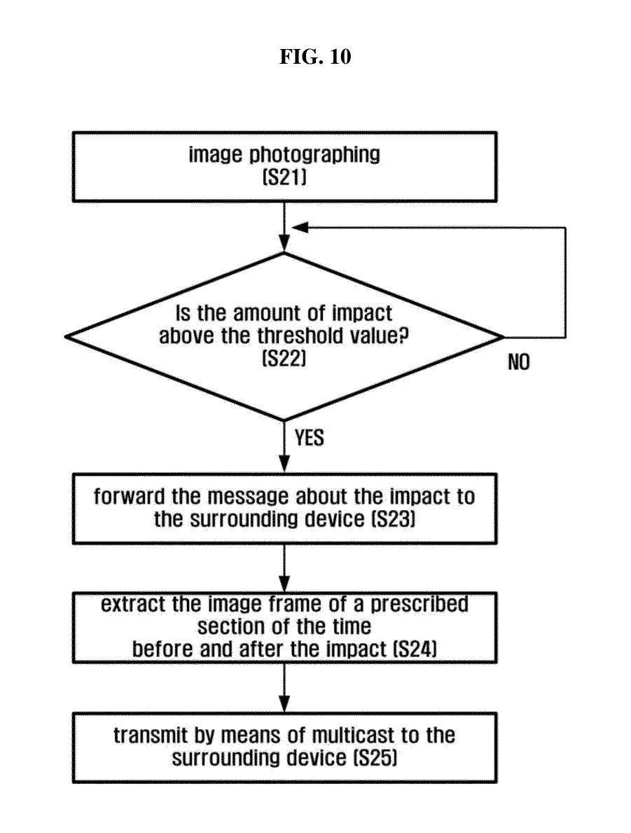

FIG. 10 shows a method of transmitting data to a surrounding device when the impact is detected in the system for sharing network multimedia data in accordance with the exemplary embodiments of the present invention.

A network multimedia device, when the impact detected during image photographing (S21), forwards (S23) the message about the impact to a surrounding network multimedia device, given that amount of impact is above the prescribed value (S22). And it extracts the frame (S24) of a prescribed section of the time before and after the impact, and transmits the extracted frame to the surrounding devices by means of multicast (S25).

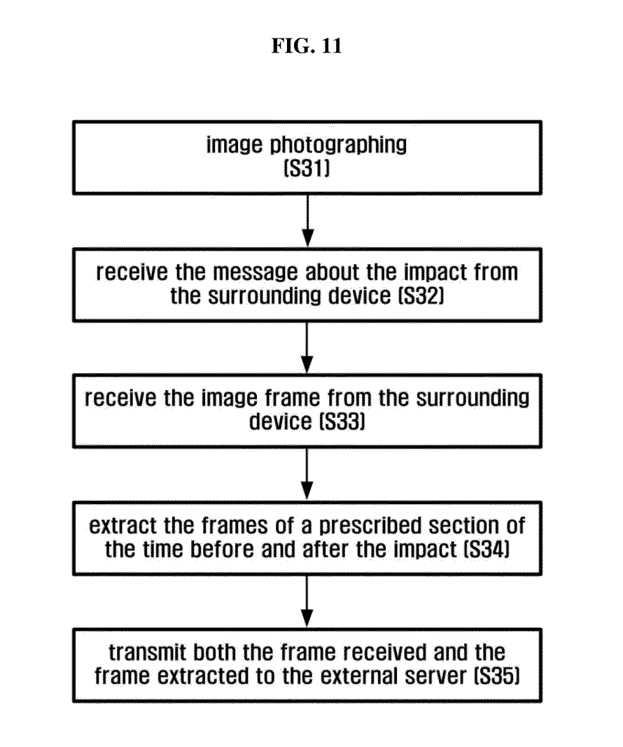

FIG. 11 shows a method of transmitting data when the message about the impact detected is received in the system for sharing network multimedia data in accordance with the exemplary embodiments of the present invention.

After receiving (S32) the message about the impact from the surrounding device during image photographing (S31), the network multimedia device receives (S33) an image frame from the device which has transmitted the message about the impact. Then, it extracts (S34) the frame, among the images taken by itself, of a prescribed section of the time before and after the message being received, and transmits (S35) both frames received and extracted to a base station.

It is clearly understandable for those having ordinary skill in the art the present invention can be embodied in various forms, other than the exemplary embodiments set forth herein, without changes in its technical idea or essential characteristic. The exemplary embodiments described herein are only for the purpose of exemplifying the present invention in all aspects, not of limiting the scope of the present invention.

### DESCRIPTION FOR MARK

10: display portion

20: sensor portion

30: control portion

40: image processing portion

50: network portion

60: memory control portion

1. A system for sharing network multimedia data, comprising
a first display portion which displays a first information about a surrounding area; and
a second display portion which displays a first image provided by a surrounding device in the surrounding area,
wherein the surrounding device is connected on a same ad hoc network, and the first image is received over the ad hoc network.

2. According claim 1,
a system for sharing network multimedia data, further comprising
a sensor portion which detects the amount of impact applied onto a host device; and a control portion which transmits a second image of the host device at the time the accident took place to the surrounding device over the ad hoc network when the sensor portion detects the impact,

3. According to claim 2,
a system for sharing network multimedia data,
wherein the control portion of the surrounding device or the host device transmits an accident report data including a first image or the second image to an external server which is collecting images of an accident.

4. According to claim 1,
a system for sharing network multimedia data,
wherein the first display portion further displays a second information including distribution or location of the surrounding device in the surrounding area,
and the second display portion displays a third image provided by the surrounding device, in case the surrounding device displayed on the first display portion has been chosen.

5. According claim 1,
a system for sharing network multimedia data,
wherein the first display portion further displays a second information including distribution or location of the surrounding device in the surrounding area,
and the second display portion displays a forth image, provided by an
adjacent device at a specific spot in case the specific spot in the surrounding area has been chosen.
